(19) United States
(12) Patent Application Publication
(10) Pub. No.: US 2014/0164063 A1
(43) Pub. Date: Jun. 12, 2014

(54) SYSTEM AND METHOD FOR DETERMINING AFFLUENCE

(71) Applicant: Visa International Service Association, San Francisco, CA (US)

(72) Inventors: Sandra Delrahim, Foster City, CA (US); Charles Raymond Byce, Foster City, CA (US)

(21) Appl. No.: 13/910,720

(22) Filed: Jun. 5, 2013

Related U.S. Application Data
(60) Provisional application No. 61/734,666, filed on Dec. 7, 2012.

(51) Int. Cl. G06Q 30/02

(52) U.S. Cl. CPC G06Q 30/0205
USPC 705/7.34

(57) ABSTRACT

A system and method for determining affluence is provided. A plurality of accounts associated with a first geographic area are identified with each account has a number of transactions in a historical spend database associated with it that exceed a frequency of use threshold. The average income of the geographic area exceeds a predetermined income threshold. A total spend for each account from transactions in the historical spend database is associated with a spending range. The discretionary portion of the total spend for each account from transactions in the historical spend database is determined. An affluence category is associated with each account based on the total spend and the discretionary portion of the total spend of each account.

### CROSS REFERENCE TO RELATED APPLICATIONS

The present application claims priority to U.S. Application Ser. No. 61/734,666, filed on Dec. 7, 2012, and entitled “System and Method for Determining Affluence,” the disclosure of which is incorporated herein by reference.

### BACKGROUND OF THE INVENTION

1. Field of the Invention

The invention relates to a system and method for determining affluence. Among other fields and applications, the invention has utility in defining and assessing affluence based on relative wealth and spending habits.

2. Description of Related Art

Millions of transactions occur daily through the use of payment cards, such as credit cards, debit cards, prepaid cards, etc. Corresponding records of the transactions are recorded in databases for settlement and financial recordkeeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008, entitled “Techniques for Target Offers.”

Data is also collected based on income. Known standards of determining affluence of the population are currently based on survey data and combinations of demographic data such as income and net worth. Such information is currently collected and provided by large data providers. Such current measures of affluence are frequently determined at a national level without accounting for regional or individual differences. Current affluence measures based on generalized measures may result in overproviding offers and marketing materials to consumers. This practice ultimately results in waste of environmental resources such as paper and other unnecessary cost expenditures. Merchants ultimately pay for advertising to consumers outside the desired customer demographic. Conversely, the generalized measures may result in failing to provide offers and marketing materials to consumers who are relatively affluent, particularly in their geographic area. Therefore, a need exists for providing more individualized measures of affluence.

### SUMMARY

An apparatus is disclosed in which means for identifying a plurality of accounts associated with a first geographic area are provided. Each account has a number of transactions in a historical spend database that are determined to exceed a frequency of use threshold, wherein an average income of the first geographic area exceeds a predetermined income threshold. The apparatus also includes means for associating a total spend for each account from transactions in the historical spend database with one of a plurality of spending ranges, means for determining a discretionary portion of the total spend for each account from transactions in the historical spend database, and means for associating each account with one of a plurality of affluence categories based on the total spend and the discretionary portion of the total spend.

A system is disclosed that comprises one or more processors and a memory containing processor-executable instructions that, when executed by the one or more processors, cause the system to identify a plurality of accounts associated with a first geographic area, each account having a number of transactions that exceeds a frequency of use threshold, wherein an average income of the first geographic area exceeds a predetermined income threshold, wherein the predetermined income threshold is a number associated with a measure of a relative wealth of the first geographic area to a second geographic area, the second geographic area encompassing the first geographic area. The system is also caused to associate a total spend for each account with one of a plurality of spending ranges, determine a discretionary portion of the total spend for each account, and associate each account with one of a plurality of affluence categories based on the total spend and the discretionary portion of the total spend.

A method is disclosed in which a plurality of accounts associated with a first geographic area is identified by at least one specifically programmed processor. Each account has a number of transactions that exceeds a frequency of use threshold, wherein an average income of the first geographic area exceeds a predetermined income threshold, wherein the predetermined income threshold is a number associated with a measure of a relative wealth of the first geographic area to a second geographic area, the second geographic area encompassing the first geographic area. The method also determines, by the at least one specifically programmed processor, a total spend for each account for one year, associates the total spend for each account with one of a plurality of spending ranges, determines, by the at least one specifically programmed processor, a discretionary portion of the total spend for each account, and associates, by the at least one specifically programmed processor, each account with one of a plurality of affluence categories based on the total spend and the discretionary portion of the total spend.

In some examples, the specifically programmed computer hardware may be hardwired to perform functionality described herein, may include one or more specifically programmed software modules executing specialized computer instructions to perform functionality described herein, and/or combinations thereof. A computer implemented method is also disclosed in which a predetermined income threshold is identified, wherein the predetermined income threshold is a number associated with a measure of relative wealth. The method also determines a first geographic area and a second geographic area, the second geographic area encompassing the first geographic area, wherein an average income of the first geographic area exceeds the predetermined income threshold. The method further identifies a plurality of accounts associated with a first geographic area, each account having a number of transactions in a historical spend database that exceeds a frequency of use threshold, determines a total spend for each account from transactions in the historical spend database, associates the total spend for each account with one of a plurality of spending ranges, determines a discretionary portion of the total spend for each account from transactions in the historical spend database based on a total amount spent in discretionary categories as a percentage of the average income of the second geographic area wherein the discretionary categories include products or services purchased from specific merchants, associates each account with one of a plurality of affluence categories based on the total spend and the discretionary portion of the total spend, and provides data for display on a client device, wherein the data corresponds to at least one of the plurality of accounts and the affluence category associated with the respective account.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows a block diagram illustrating example aspects of a system for determining affluence in accordance with example embodiments.

FIG. 1a illustrates a block diagram of the databases and affluence determination server of FIG. 1 in accordance with example embodiments.

FIG. 2 illustrates a flow chart of a method of determining affluence in accordance with example embodiments.

FIG. 3 illustrates a graphical illustration of affluence categories in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, or devices. Accordingly, the present invention may take the form of an entirely hardware embodiment, an entirely software embodiment, or an embodiment combining software and hardware aspects. The following detailed description is, therefore, not to be taken in a limiting sense.

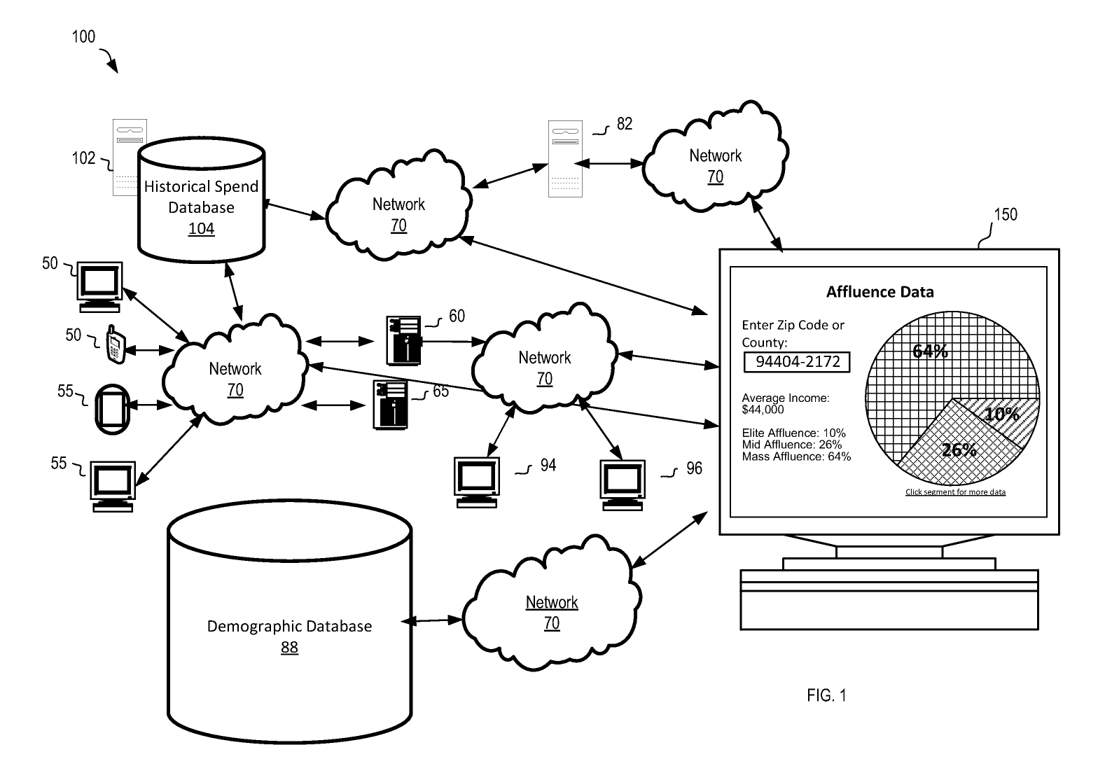

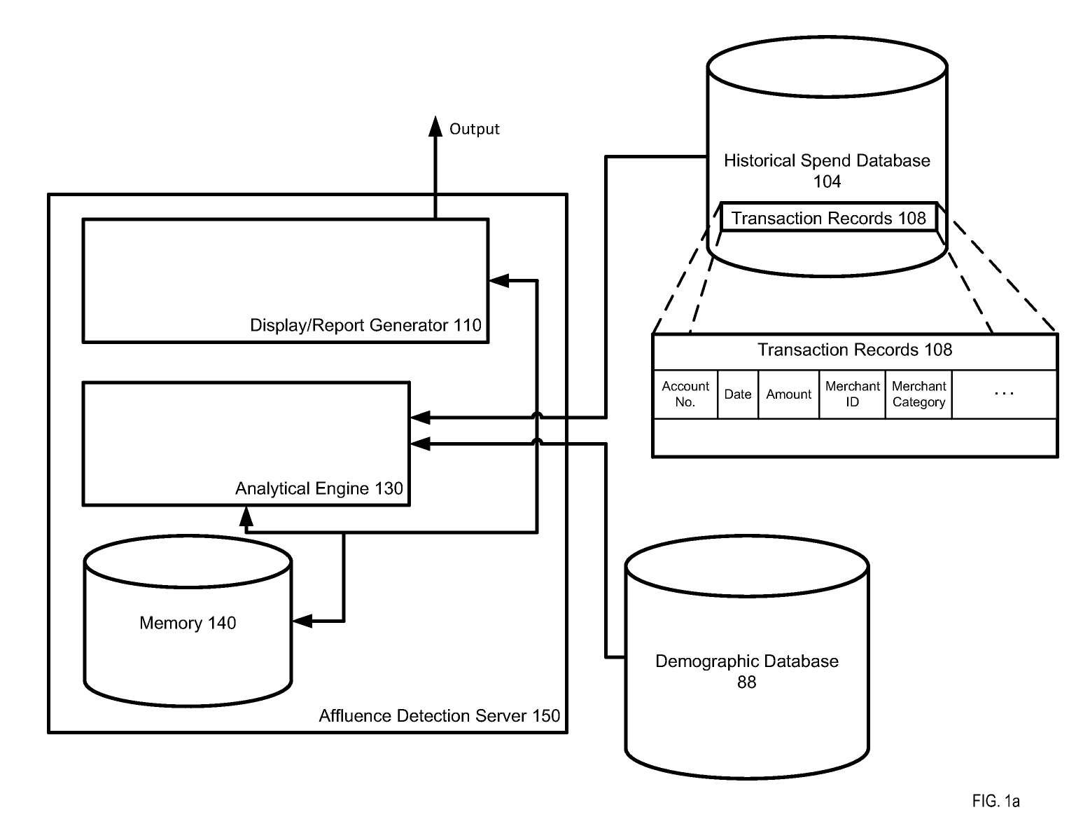

FIG. 1 illustrates a block diagram of a system 100 for determining affluence in accordance with example embodiments. System 100 may include one or more client device including merchant devices such as terminals 50 and 55, one or more e-commerce provider servers 60 and 65, one or more payment network servers 102, which may include historical spend database 104, one or more merchant servers 82 one or more affluence determination servers 150, and one or more e-commerce provider user terminals 94 and 96. Networks 70 are shown interconnecting various components. Networks 70 may be the Internet, WAN, LAN, Wi-Fi, other computer networks (now known or invented in the future), and/or any combination of the foregoing. It should be understood by those of ordinary skill in the art having the present specification, drawings, and claims before them that networks 70 may connect the various components over any combination of wired and wireless conduits, including copper, fiber optic, microwaves, and other forms of radio frequency, electrical and/or optical communication techniques. It should also be understood that any network 70 may be connected to any other network 70 in a different manner. The interconnections between devices in system 100 are examples. Any device depicted in FIG. 1 may communicate with any other device via one or more of the networks 70.

Servers 60, 65, 82, 102, and 105 may be general purpose computers that may have, among other elements, a microprocessor (such as from the Intel Corporation, AMD, or Motorola); volatile and non-volatile memory; one or more mass storage devices (i.e., a hard drive); various user input devices, such as a mouse, a keyboard, or a microphone; and a video display system. Servers 60, 65, 82, 102, and 105 may be running on any one of many operating systems including, but not limited to WINDOWS, UNIX, LINUX, MAC OS, or Windows (XP, VISTA, etc.). It is contemplated, however, that any suitable operating system may be used for the present invention. Servers 60, 65, 82, 102, and 105 may be a cluster of web servers, which may each be LINUX based and supported by a load balancer that decides which of the cluster of web servers should process a request based upon the current request-load of the available server(s).

Payment network server 102 may acquire, send, process, and store information in conjunction with historical spend database 104. In some embodiments, historical spend database 104 includes merchant data (e.g., data about sellers including a merchant ID), customer spend data(e.g., transaction records between sellers and buyers over time), information of merchants, categories of the merchants, and may further include geographical location categories of products and services provided by merchants. Merchant information associated with a transaction may also be determined using the merchant ID recorded for the transaction. Demographic database 88 may include one or more databases and can store information including and related to average income, geographic information, and other demographic data. Demographic database 88 may be provided by one or more third parties (e.g., large database providers), one or more issuers, or a combination of one or more issuers and third parties. Data may be provided on an on-demand basis or may be batch delivered to affluence detection server 150. Data accessed and generated by affluence detection server 150, including but not limited to the illustrated affluence data may be provided for display on any one or more client or merchant devices including terminals 50 and 55. Issuers and other users, such as mail marketers or other advertisers, may also be provided with data accessed and generated by affluence detection server 150 though client devices connected through network 70 (not shown). Data accessed and generated by affluence detection server 150 may be provided for display on a merchant dashboard, accessed by a client device such as terminals 50 and 55. The merchant dashboard may be accessed through a web browser.

Terminals 50, 55, 94, and 96 may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones, computers, laptops, and the like. In one aspect, the general-purpose computer may be controlled by the WINDOWS XP operating system. It is contemplated, however, that the present system would work equally well using a MACINTOSH computer or even another operating system such as a WINDOWS VISTA, UNIX, LINUX or a JAVA based operating system, to name a few.

Terminals 50, 55, 94, and 96 may operably connect to servers 60, 65, 82, 102, and 105, via one of many available internet browsers including, but not limited to, Microsoft's Internet Explorer, Apple's Safari, and Mozilla's Firefox. Via any of networks 70, end users may access the system 100 with an http-based website, although other graphical user interfaces can be used with the present system. Information entered by an end user via terminals 50, 55, 94, and 96 may be encrypted before transmission over a network for additional security. There are several commercially available encryption programs or algorithms available including, but not limited to, PC1 Encryption Algorithm, TrueCrypt, a Symantec encryption program, Blowfish, and Guardian Edge.

E-commerce provider servers 60 and 65 may provide a digital marketplace through which on-line merchants may provide services, offer products for sale, and provide offers and deals. In an example, e-commerce provider servers 60 and 65 may host websites that can be accessed by client or merchant terminals 50 and 55 via network 70.

Transactions occurring through client or merchant terminals 50 and 55, servers 60 and 65, payment network servers 102, merchant servers 82, e-commerce provider terminals 94 and 96, and accompanying networks 70 are portions of system 100 through which expenditures may be made for an account. Information such as type of merchant, type of purchase, type of good or service, may be collected and transferred directly or indirectly to affluence determination server 150 in addition to information from demographic database 88.

Affluence determination server 150 may be running on any one of many operating systems including, but not limited to WINDOWS, UNIX, LINUX, MAC OS, or Windows (XP, VISTA, etc.). It is contemplated, however, that any suitable operating system may be used for the present invention. Affluence determination server 150 may be a cluster of web servers, which may each be LINUX based and supported by a load balancer that decides which of the cluster of web servers should process a request based upon the current request-load of the available server(s).

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices. System 100 may determine affluence of accounts based on information provided to and/or obtained by affluence data server 150 from a variety of sources including those depicted in FIG. 1 including historical spend database 104 and demographic database 88.

FIG. 1a illustrates a block diagram of the demographic database 88, the historical spend database 104, and the affluence determination server of FIG. 1 in accordance with example embodiments. Affluence detection server 150 may be connected to demographic database 88 and historical spend database 104 through networks 70 as illustrated in FIG. 1. Affluence detection server 150 includes display/report generator 110, analytical engine 130, and memory 140. Historical spend database 104 may include transaction records 108.

Transaction records 108 stored in historical spend database may be acquired from various client and merchant devices via networks 70. Transaction records 108 may include account number information, date of purchase information, purchase amount, merchant ID, merchant categories, and the like. In some embodiments, transaction records may include details about the products and/or services involved in the purchase and stored with transaction records 108. For example, a list of items purchased in the transaction may be recorded together with the respective purchase prices of the items and/or the respective quantities of the purchased items. The products and/or services can be identified via stock-keeping unit (SKU) numbers, or product category IDs. The purchase details may be stored in a separate database and be looked up based on an identifier of the transaction. Spending amounts may be stored in categories identified by merchant categories (e.g., as represented by a merchant category code (MCC), a North American Industry Classification System (NAICS) code, or a similarly standardized category code).

Transaction records 108 along with other information from historical spend database 104 and information from demographic database 88 server provide input for the affluence detection server 150. Analytical engine 130 is configured to execute instructions, such as instructions physically coded into the analytical engine 130, instructions stored in memory 140, instructions stored over a network 70, or from a combination of sources. Analytical engine 130 receives information from the databases 88 and 104 and determines affluence in accordance with the subject technology. Memory 140 be comprised of one or more databases and may be physically located in the affluence detection server 150 or connected to affluence detection server 150 through any network 70. Memory 140 may be volatile, non-volatile, or may incorporate both. Memory 140 may store instructions that are executed by analytical engine 130 to determine affluence and may also store database information including past determinations of affluence.

Display/report generator 110 receives information from analytical engine 130 and/or memory 140 and provides display and report information as output to any device configured to receive and/or display such information including, but not limited to, client devices including merchant devices, issuer devices, and servers (not shown). The data accessed and generated by analytical engine 130 and/or memory 140 and provided by display/report generator 110 for display may be in a variety of forms. Such output may be configured or individualized by the recipient of the data. Data that can be provided for display may include additional information. For example, data that is provided for display as part of a merchant dashboard may include additional information that may be useful and/or interesting to that merchant in operating their business. All or some of the data may be displayed using graphical representations, including but not limited to graphs, pie charts, and line graphs. The data may also be transmitted directly to interested parties (e.g. merchants) via email or other type of messaging protocol or by providing a link to such data.

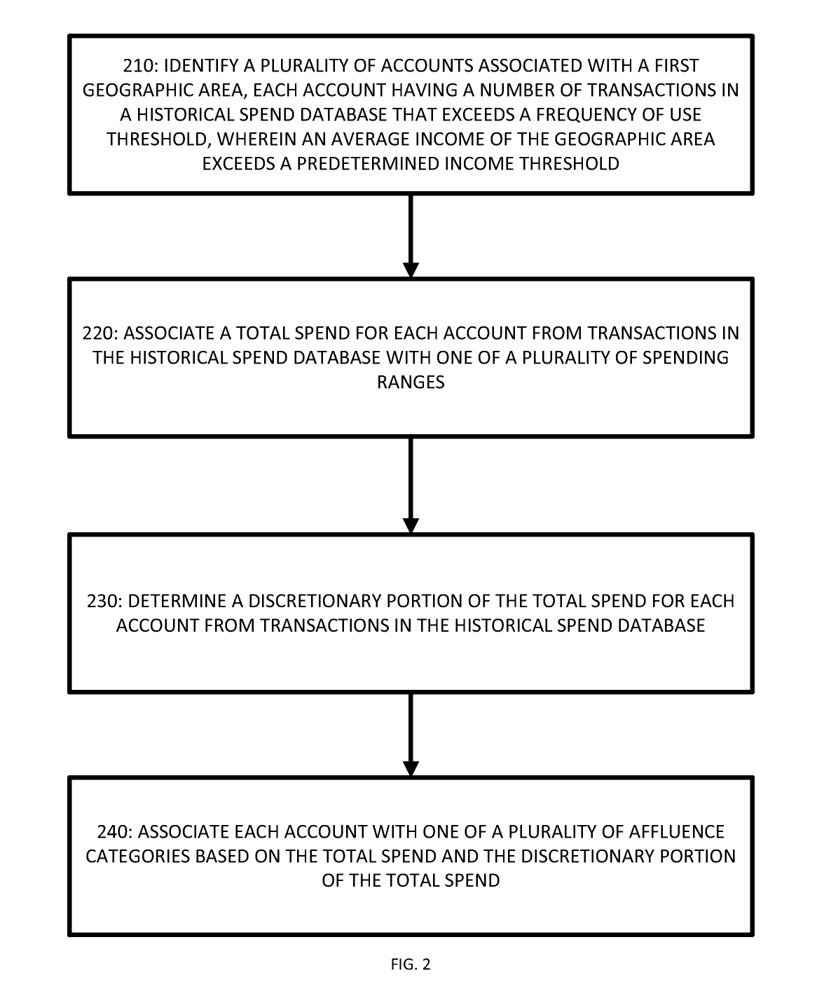

FIG. 2 illustrates a flow chart of a method of determining affluence in accordance with example embodiments. The flow diagram may be implemented by a dedicated system or dedicated apparatus, such as, for example, affluence determination server 150. Affluence determination server 150 includes specifically programmed computer hardware performing the functions described herein. Examples of the specifically programmed computer hardware include display/report generator 110, Analytical Engine 130, and Memory 140. In some examples, the specifically programmed computer hardware may be hardwired to perform functionality described herein, may include one or more specifically programmed software modules executing specialized computer instructions to perform functionality described herein, and/or combinations thereof. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The method performed may begin at block 210.

In block 210, a plurality of accounts associated with a first geographic area may be identified. Each account may have a number of transactions in a historical spend database 104 that meet or exceed a frequency of use threshold. Further, an average income of the geographic area exceeds a predetermined income threshold. Average income information for one or more geographic areas, may be obtained from demographic database 88. Accounts may be associated with one or more of a credit card, debit card, reward card, gift card or other payment card via a multiple digit personal account number (PAN). Accounts may alternatively or additionally be associated with a checking account, savings account, on-line account, or other account of one or more users. One account of the plurality of accounts may constitute an account of a user that includes several different accounts. An account of a user may be all the accounts for a household, several cards linked to a single bank account, all the accounts of an individual, several different accounts that are associated with an individual, all the accounts associated with a physical address, all or some of the accounts associated with an individual at a single physical address, or the like. The first geographic area may be a zip code, zip+2 code, zip+3 code, a zip+4 code, or any definable geographic area. The accounts that are identified may include some or all of the accounts that are associated with a physical address located within a zip code, or zip+4 code.

The frequency of use threshold may be a minimum number of transactions per year (e.g., a rolling twelve month period) or any other period selected dynamically or statically. By way of example only, the threshold number of transactions may be set at any number. In one example, the minimum number of transactions per year may be selected to be twenty-four. The actual number chosen for the threshold may be chosen such that the identified accounts are used frequently enough to provide an adequate representation of the individual's spending habits. The threshold may be adjusted by a user automatically using a computer implemented algorithm depending on the desired outcome.

The identified accounts may be further filtered by identifying only accounts that are associated with geographic areas with average incomes that meet or exceed a predetermined income threshold. This filter may preliminarily identify accounts that are more likely to be affluent based on a geographic component. The predetermined income threshold may be any number associated with a measure of relative wealth of the first geographic area to a second geographic area, the second geographic area encompassing the first geographic area. For example, the first geographic area may be a zip+4 code and the second geographic area may be the county in which the zip+4 code is located. The relationship of the first geographic area to the second geographic area may be scaled to any size. For example, the first geographic area may be a state and the second geographic area may be the country in which the state is located. Geographic information may be obtained from demographic database 88.

Relative affluence of the first geographic area with respect to the larger, second geographic area may be used to normalize the income level across different geographies. The measure of the relative wealth of the first geographic area may be an income index. For example, the predetermined income threshold may be set such that the average income of individuals or households in the first geographic area must be fifty percent or greater than the average individual or household income of the larger, second geographic area. That is, the predetermined income threshold may be set to an income index of 150. The income index value is thus calculated by dividing the average income of the first geographic area by the average income of the second geographic area and multiplying by 100. Any other known measure of identifying relative wealth in a geographic area may be used. Further, the first geographic area may include multiple geographic areas; for instance, the first geographic area may include some or all of the zip+4 codes located within the second geographic area (e.g., a county or state) where the average income of each zip+4 code exceeds the predetermined income threshold.

In one example, following block 210, the identified accounts may constitute credit card users having over 24 transactions in the last year that are associated with a zip+4 code (first geographic area) with an average income of $48,000. For the purposes of this example, the zip+4 will be 94404-2172, which we shall refer to as being in a fictional place called Pleasant City. Pleasant City is located in Summer County (second geographic area). Summer County's average income is $32,000. Accordingly, the income index value of Pleasant City to Summer County is 150. Using an income index value of 150 as the predetermined income threshold, credit card accounts with more than 24 transactions in the last year in Pleasant City are identified. Accounts A, B, and C are among the identified accounts.

In block 220, a total spend for each account from transactions in the historical spend database 104 may be associated with one of a plurality of spending ranges. Total spend for each account may include the total dollar amount spent in one year through each account. The time span of one year is used throughout the description of the method of FIG. 2, although any span of time may be used. Similarly, the description of the method of FIG. 2 refers to the amount spent in dollars, although any type of currency may be used to describe monetary amounts. Each of the plurality of spending ranges may be associated with a total amount spent in one year. The plurality of spending ranges represent a spectrum of total annual money spent by any particular electronic payment account. One of many examples of spending ranges may be a set of three spending ranges: less than $10,000 a year; $10,000-$30,000 a year; and more than $30,000 a year.

Continuing the above example, the total spend of account A is $4,000, the total spend of account B is $12,000, and the total spend of account C is $50,000. Thus, following block 220, account A is associated with the less than $10,000 a year range, account B is associated with the $10,000-$30,000 a year range; and account C is associated with the $50,000 range.

In block 230, a discretionary portion of the total amount of money spent from each account from transactions in the historical spend database 104 may be determined. The discretionary portion may be determined based on a total amount of money spent in discretionary categories. Discretionary categories may be determined based on the type of product or service purchased, the type of merchant that the product or service is purchased from, and/or based on specific merchants. For example, discretionary products and services may include purchases such as plane tickets, car rentals, hotel stays, cruise tickets, clothing, furniture, electronics, memberships to health clubs, memberships to on-line movie streaming, music purchases, any purchase of travel, any purchase of electronics, purchases from direct marketing, and the like. Discretionary categories may be determined based on the requestor of affluence information or may be automatically determined using past analysis. Examples of non-discretionary spending may include everyday purchases such as gas, grocery, and drugstore purchases.

Continuing with the above example, account A's total spend of $4,000, has been spent on groceries; thus, account A has a discretionary spend of $0 dollars. Of account B's $12,000 spend, exactly half was spent on gas with the remaining half spent on a resort vacation package; thus, account B has a non-discretionary spend of $6,000 and a discretionary spend of $6,000. Account C's total spend of $50,000 was spent entirely on purchases from luxury goods providers and fine dining restaurants; account C has a discretionary spend of $50,000.

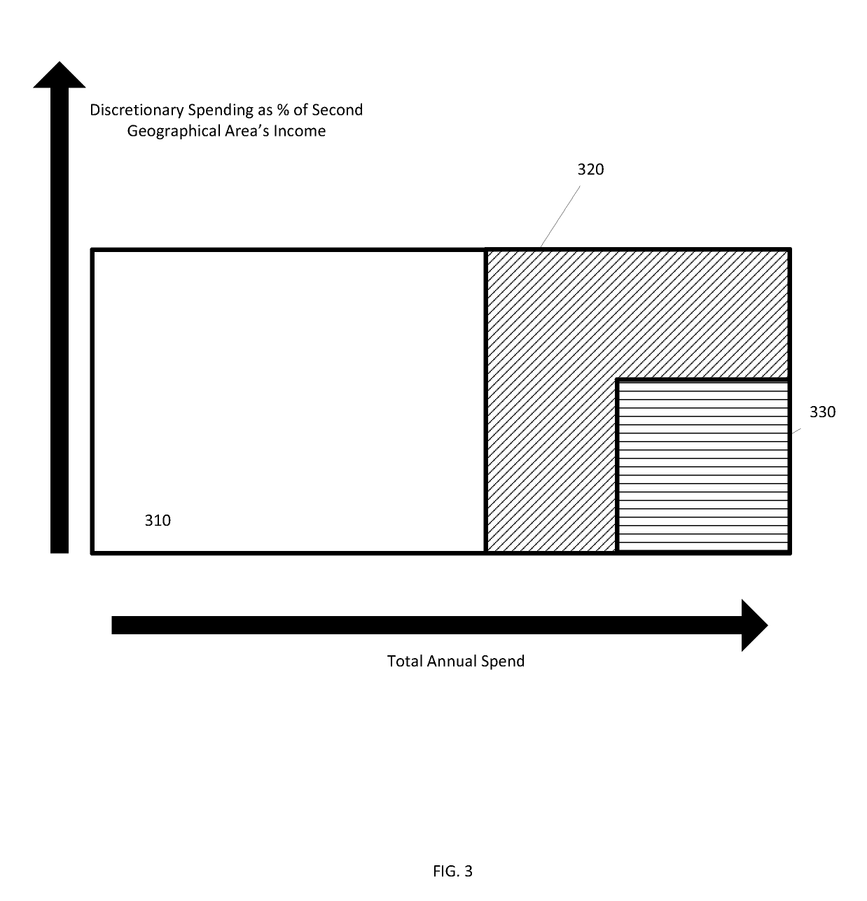

In block 240, each account may be associated with one of a plurality of affluence categories based on the total spend and the discretionary portion of the total spend. Affluence categories may be determined based on the total amount of discretionary expenditures in one year for an account as a percentage of the second geographical area's income and also based on the total amount of money spent per year. The ranges that define each affluence categories may vary. In one non-limiting example, a mass affluent category may be defined as an account whose total spending is below $10,000 in one year with a discretionary spending total of less than 30% of the second geographic area's average income; a mid-affluent category may be defined as an account whose total spend is between $10,000 and $30,000 with a discretionary spending total of less than 30% of the second geographic area's average income; and an elite affluent category as an account whose total spend is above $30,000 in one year with a discretionary spending total that equal to or greater than 30% of the second geographic area's average income. A graphical representation of this non-limiting example is illustrated in FIG. 3, where 310 represents the mass affluent category, 320 represents the mid affluent category, and 330 represents the elite affluent category. It is understood that in other examples, each category may be defined by any variety of characteristics and that the number of categories may also vary.

With respect to the above example, account A's discretionary spend constitutes 0% of Summer County's, the second geographic area, average income of $32,000. Account B's discretionary spend of $6,000 constitutes 18.75% of Summer County's average income. Account C's discretionary spend of $50,000 constitutes 156.25% of Summer County's average income. Accordingly, account A is associated with the mass affluent category with total spend of less than $10,000 and a discretionary spend that is less than 30% of Summer County's average income. Account B is associated with the mid affluent category with total spend between $10,000 and $30,000 and a discretionary spend that is less than 30% of Summer County's average income. Finally, account C is associated with the elite affluent category with a total spend above $30,000 and a discretionary spend that is greater than 30% of Summer County's average income.

The determination in FIG. 2 may end, may repeat one or more times, or may return to any of the preceding blocks. The determination in FIG. 2 may alternatively be performed for a single account, rather than for a plurality of accounts. The determination of FIG. 2 furthers goals of the invention such as determining affluence on a more individual basis and determining affluence that is based on individual spending habits. Accounts that have been identified in an affluence category may be used for more effective directing marketing of discretionary products to individuals and households to which they are most relevant. The determination in FIG. 2 may be performed for multiple first geographic areas such that accounts are associated with affluence categories in multiple geographic areas. For instance, first geographic areas could include all zip+4s in a zip code. The zip code could then be used as the second geographic area.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system, it will be understood by those of ordinary skill in the art having the present specification, figures, and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithms may be expressed within this disclosure as a mathematical formula, a flow chart, a narrative, and/or in any other manner that provides sufficient structure for those of ordinary skill in the art to implement the recited process and its equivalents.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 100 and the methods described herein may be configured to determine affluence. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. An apparatus comprising:
identifying a plurality of accounts associated with a first geographic area, each account having a number of transactions in a historical spend database that exceeds a frequency of use threshold, wherein an average income of the first geographic area exceeds a predetermined income threshold;
associating a total spend for each account from transactions in the historical spend database with one of a plurality of spending ranges;
determining a discretionary portion of the total spend for each account from transactions in the historical spend database based on a total amount spent in discretionary categories from transactions in the historical spend database as a percentage of an average income of a second geographic area; and
associating each account with one of a plurality of affluence categories based on the total spend and the discretionary portion of the total spend, wherein the associated affluence category is further based on the discretionary portion of the total spend meeting or exceeding one or more affluence thresholds.

2. The apparatus of claim 1, wherein the predetermined income threshold is a number associated with a measure of a relative wealth of the first geographic area to the second geographic area, the second geographic area encompassing the first geographic area.

3. The apparatus of claim 2, wherein the measure of the relative wealth of the first geographic area is an income index.

4. The apparatus of claim 1, wherein the first geographic area is one of a zip code or a zip+4 code.

5. The apparatus method of claim 1, the method further comprising:
providing data for display on a client device, wherein the data corresponds to at least one of the plurality of accounts and the affluence category associated with the respective account.

6. The apparatus method of claim 2, the method further comprising:
determining the total spend for each account from transactions in the historical spend database for one year.

7. (canceled)

8. The apparatus of claim 1, further comprising identifying a plurality of accounts associated with a plurality of first geographic areas.

9. A system comprising:
one or more processors; and
a memory containing processor-executable instructions that, when executed by the one or more processors, cause the system to:
identify a plurality of accounts associated with a first geographic area, each account having a number of transactions that exceeds a frequency of use threshold, wherein an average income of the first geographic area exceeds a predetermined income threshold, wherein the predetermined income threshold is a number associated with a measure of a relative wealth of the first geographic area to a second geographic area, the second geographic area encompassing the first geographic area;
associate a total spend for each account with one of a plurality of spending ranges;
determine a discretionary portion of the total spend for each account based on a total amount spent in discretionary categories from transactions in the historical spend database as a percentage of an average income of a second geographic area; and
associate each account with one of a plurality of affluence categories based on the total spend and the discretionary portion of the total spend, wherein the associated affluence category is further based on the discretionary portion of the total spend meeting or exceeding one or more affluence thresholds.

10. The system of claim 9, wherein the measure of the relative wealth of the first geographic area is an income index and wherein income information associated with the first geographic area and the second geographic area is stored in a demographic database.

11. The system of claim 9, wherein the first geographic area is one of a zip code or a zip+4 code.

12. The system of claim 9, the system further configured to:
provide data for display on a client device, wherein the data corresponds to at least one account and the affluence category associated with the account.

13. The system of claim 9, the system further configured to:
determine the total spend for each account for one year and transactions of each account are stored in a historical spend database.

14. (canceled)

15. The system of claim 9, wherein the method is performed for a plurality of first geographic areas.

16. A method comprising:
identifying, by at least one specifically programmed processor, a plurality of accounts associated with a first geographic area, each account having a number of transactions that exceeds a frequency of use threshold, wherein an average income of the first geographic area exceeds a predetermined income threshold, wherein the predetermined income threshold is a number associated with a measure of a relative wealth of the first geographic area to a second geographic area, the second geographic area encompassing the first geographic area;
determining, by the at least one specifically programmed processor, a total spend for each account for one year;
associating, by the at least one specifically programmed processor, the total spend for each account with one of a plurality of spending ranges;
determining, by the at least one specifically programmed processor, a discretionary portion of the total spend for each account based on a total amount spent in discretionary categories from transactions in the historical spend database as a percentage of an average income of a second geographic area; and
associating, by the at least one specifically programmed processor, each account with one of a plurality of affluence categories based on the total spend and the discretionary portion of the total spend wherein the associated affluence category is further based on the discretionary portion of the total spend meeting or exceeding one or more affluence thresholds.

17. The method of claim 16, wherein the measure of the relative wealth of the first geographic area is an income index.

18. The method of claim 16, wherein the first geographic area is one of a zip code or a zip+4 code.

19. The method of claim 16, the method further comprising:
providing, by the at least one specifically programmed processor, data for display on a client device, wherein the data corresponds to at least one of the plurality of accounts and the affluence category associated with the respective account.

20. The method of claim 16, the method further comprising:
determining, by the at least one specifically programmed processor, the discretionary portion based on a total amount spent in discretionary categories as a percentage of the average income of the second geographic area.

21. A computer implemented method comprising:
identifying a predetermined income threshold, wherein the predetermined income threshold is a number associated with a measure of relative wealth;
determining a first geographic area and a second geographic area, the second geographic area encompassing the first geographic area; wherein an average income of the first geographic area exceeds the predetermined income threshold;
identifying, by at least one specifically programmed processor, a plurality of accounts associated with the first geographic area, each account having a number of transactions in a historical spend database that exceeds a frequency of use threshold;
determining a total spend for each account from transactions in the historical spend database;
associating the total spend for each account with one of a plurality of spending ranges;
determining a discretionary portion of the total spend for each account from transactions in the historical spend database based on a total amount spent in discretionary categories as a percentage of the average income of the second geographic area wherein the discretionary categories include products or services purchased from specific merchants and wherein the associated affluence category is further based on the discretionary portion of the total spend meeting or exceeding one or more affluence thresholds;
associating each account with one of a plurality of affluence categories based on the total spend and the discretionary portion of the total spend; and
providing data for display on a client device, wherein the data corresponds to at least one of the plurality of accounts and the affluence category associated with the respective account.
